(19) United States
(12) Patent Application Publication
(10) Pub. No.: US 2017/0169050 A1
(43) Pub. Date: Jun. 15, 2017

(54) METHOD AND ELECTRONIC DEVICE FOR FILE SYSTEM SYNCHRONIZATION

(71) Applicants: Le Holdings (Beijing) Co., Ltd., Beijing (CN); Lemobile Information Technology (Beijing) Co., Ltd, Beijing (CN)

(72) Inventor: Yu TIAN, Beijing (CN)

(21) Appl. No.: 15/250,840

(22) Filed: Aug. 29, 2016

Related U.S. Application Data
(63) Continuation of application No. PCT/CN2016/088938, filed on Jul. 6, 2016.

(30) Foreign Application Priority Data
Dec. 11, 2015 (CN) 201510921266.4

(51) Int. Cl. G06F 17/30

(52) U.S. Cl. CPC G06F 17/30174; G06F 17/30106; G06F 17/30023

(57) ABSTRACT

Disclosed are method and electronic device for file system synchronization The method includes: at an electronic device: acquiring first storage attribution information of a file, and second storage attribute information of the file from a database where the file stored; comparing the first storage attribute information with the second storage attribute information to generate a corresponding comparison result; and determining a corresponding synchronization policy according to different comparison results, and synchronizing the second storage attribution information in the database according to the determined synchronization policy. According to the embodiments of the present application, inconvenience, such as reported errors in file reading caused due to non-synchronization of a terminal SD card and the database in terms of file management and the like is addressed.

### CROSS REFERENCE TO RELATED APPLICATIONS

This application is a continuation of International Application No. PCT/CN2016/088938, filed on Jul. 6, 2016, which claims priority to Chinese Patent Application No. 201510921266.4, filed on Dec. 11, 2015, the entire contents of which are incorporated herein by reference.

### TECHNICAL FIELD

The disclosure relates to the field of Internet technologies, and more particularly, to a method and an electronic device for file system synchronization.

### BACKGROUND

In compliance with the trends of “smart-orientation”, “network-orientation” and “portable-orientation” of traditional mobile phones, smart terminals are emerging. Using Android mobile phones and tablets are an example, these terminals integrate the Internet, camera, sensor and the like hardware and relevant software devices, and generate various multimedia information sources. The multimedia information, such as pictures, music and videos cause different audio-visual experience to users. The multimedia information may be originated from the Internet, or may be originated from digitalized information generated by the terminal, such as the camera. From the perspective of the system, the multimedia information is an indispensable constitutional part of the system.

Using storage of pictures on an Android mobile phone as an example, pictures, as an important constitutional part of the multimedia, are frequently used in a smart terminal such as an Android mobile phone, and the pictures are generally stored in various file folders on the mobile phone. For convenience in finding the pictures by a user, the files in the mobile phone are categorized and organized, an index is established, and the index is stored to a specific location of a memory card of the mobile phone, that is, a database of the mobile phone. By categorization of different types of files, the files are aggregated according to file folders, which facilitates the user in directly finding all the files of different types and locations thereof in the memory card of the mobile phone.

FIG. 7 is a schematic diagram illustrating picture storage in the related art. As illustrated in FIG. 7, the file with a suffix “.jpg” is a picture. For example, the file “IMG_20140924_094149.jpg” belongs to a “Camera” file folder, and the “Camera” file folder belongs to a “DCIM” file folder. These file folders are stored in the mobile phone in a tree structure. FIG. 8 is a schematic diagram illustrating picture merging in the related art. As illustrated in FIG. 8, a photo album, as a management tool of pictures, identifies the pictures from a file folder, and categorizes and organizes the pictures in the form of file folders; and if pictures are present in the current file folder, the picture categorization and organization is conducted under this file folder.

The information and number of picture folders in FIG. 8 may be acquired by querying the index items of the database. These items are provided by the Media Scanner service and the Media Provider data content provider at the bottom layer of the Android system. The Media Scanner is configured to scan the pictures, videos, audios and the like file information currently stored in the memory card (also referred to as an SD card) of the mobile phone, and establish an index to the database. The database records types of files, for example, pictures, videos or audios and the like, generation time, file path, for example, file mane of the file folder+file name, and file size. In case of pictures, shooting time of the pictures, length, width and geographic location information of shooting place of the pictures, and dedicated information such as manufacturer information of aperture and flash lamp of the pictures. The Media Provider provides an interface for an upper layer application to access the database.

The photo album is considered to be the upper layer application, and directly accesses the files in the database by accessing the Media Provider interface to find the pictures categorized according to the file folders and display the pictures on the screen. All the information of the pictures presented on the screen is directly originated from the database, and the photo album operates the pictures by accessing the Media Provider. The Media Provider acts as a connecting link. For example, when a picture is deleted, the Media Provider firstly deletes the index thereof from the database, and the deletes the corresponding picture in the SD card to ensure that the index is consistent with the SD card. At present, the user may perform operations such as add, delete, modify and the like for the pictures by using the photo album. However, when the user performs these operations, the currently prevailing photo album software may fail to directly access the SD card to modify the pictures, because direct access to the SD card may result in that the database index is inconsistent with the pictures in the SD card. For example, picture A in the SD card is deleted, but the index of the database still records related information of picture A; or picture B is added, but the index of the database has no corresponding added information. As a result, the pictures displayed on the interface are inconsistent with the pictures actually stored in the DS card.

In addition, the pictures on mobile phones may also be managed by third-party applications mounted thereon. However, the manner of operating the local pictures by using these applications does not satisfy the standard, during operating of the pictures, such as add, delete and modify, it is probable that the SD card is only operated or the database is only operated. As a result, the pictures in the SD card are inconsistent with those in the database. As such, inconvenience may be generally caused to the management of the pictures by the application. For example, the user detects that a picture is still being displayed in the photo album, but actually this picture is not stored in the SD card. In this case, when the user is to copy or share this picture to another user to operate, an error may be caused.

The above problem in the related art may be summarized as being caused due to non-synchronization of the SD card and the database in terms of file management, for example, picture management. Therefore, a synchronization solution in terms of file management between the SD card and the database is urgently desired.

### SUMMARY

The present application is to provide a method and an electronic device for file system synchronization, to address inconvenience, such as reported errors in file reading caused due to non-synchronization of a terminal SD card and the database in terms of file management and the like in the related art.

The embodiments of the present invention employ technical solutions as follows:

An embodiment of the present application provides a method for file system synchronization, which includes:

acquiring first storage attribution information of a file, and second storage attribute information of the file from a database where the file stored;

comparing the first storage attribute information with the second storage attribute information to generate a corresponding comparison result; and

determining a corresponding synchronization policy according to different comparison results, and synchronizing the second storage attribution information in the database according to the determined synchronization policy.

An embodiment of the present application further provides an electronic device for file system synchronization, comprising: at least one processor; and a memory communicably connected with the at least one processor for storing instructions executable by the at least one processor, wherein execution of the instructions by the at least one processor causes the at least one processor to:

acquire first storage attribution information of a file and second storage attribute information of the file from a database where the file stored;

compare the first storage attribute information with the second storage attribute information to generate different comparison results; and

determine a corresponding synchronization policy according to the different comparison results, and synchronize the second storage attribution information in the database according to the determined synchronization policy.

An embodiment of the present application further provides a non-transitory computer-readable storage medium storing executable instructions that, when executed by an electronic device, cause the electronic device to:

acquire first storage attribution information of a file, and second storage attribute information of the file from a database where the file stored;

compare the first storage attribute information with the second storage attribute information to generate a corresponding comparison result; and

determine a corresponding synchronization policy according to different comparison results, and synchronize the second storage attribution information in the database according to the determined synchronization policy.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating a method for file system synchronization according to Embodiment 1 of the present application;

FIG. 2 is a schematic application diagram illustrating comparison according to Embodiment 2 of the present application;

FIG. 3 is a schematic flowchart illustrating a picture system synchronization method according to Embodiment 3of the present application;

FIG. 4 is a schematic structural diagram illustrating a file system synchronization apparatus according to Embodiment 4 of the present application;

FIG. 5 is a schematic structural diagram of a smart terminal according to Embodiment 5 of the present application;

FIG. 6 is a schematic flowchart illustrating a method for file system synchronization according to Embodiment 6 of the present application;

FIG. 7 is a schematic diagram illustrating picture storage in the related art; and

FIG. 8 is a schematic diagram illustrating picture merging in the related art.

### DETAILED DESCRIPTION

To make the objectives, technical solutions and advantages of the embodiments of the present application clearer, the technical solutions according to the embodiments of the present application are clearly and thoroughly described with reference to the accompanying drawings of the embodiments of the present application. The described embodiments are merely exemplary ones, but are not all the embodiments of the present application. Based on the embodiments of the present application, all other embodiments derived by persons of ordinary skill in the art without any creative efforts shall fall within the protection scope of the present application.

In this embodiment, the technical solutions of the embodiments of the present application are described using the picture as the file. However, under teachings of the embodiments of the present application persons of ordinary skill in the art may also apply the technical solutions of the embodiments of the present application to other types of files such as videos, audios and office-related files without paying any creative effort. The details are not given herein any further.

In the embodiments described hereinafter, the technical solutions according to the embodiments of the present application are described using the scenario where pictures are stored on a smart terminal, for example, an SD card on the smart terminal, as an example. However, under teachings of the embodiments of the present application persons of ordinary skill in the art may also apply the technical solutions of the embodiments of the present application a storage medium. The details are not given herein any further.

According to the embodiments of the present application, first storage attribution information of a file, and second storage attribute information of the file from a database where the file stored are firstly acquired; the first storage attribute information is then compared with the second storage attribute information to generate a corresponding comparison result; and a corresponding synchronization policy is determined according to different comparison results, and the second storage attribution information in the database is synchronized according to the determined synchronization policy. In this way, attribute information of a stored picture is maintained consistent with attribute information of a picture in the database, and inconvenience, such as reported errors in file reading caused due to non-synchronization of a terminal memory card and the database in terms of file management and the like is addressed.

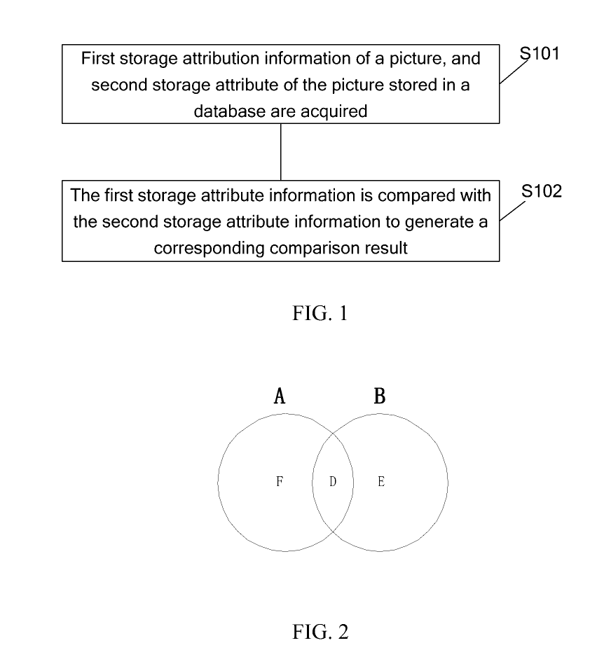

FIG. 1 is a schematic flowchart illustrating a method for file system synchronization according to Embodiment 1 of the present application. When a picture management program is started or runs at the foreground, as illustrated in FIG. 1, the method may at least include the following steps:

In S101, first storage attribution information of a picture and second storage attribute of the picture stored in a database are acquired.

In this embodiment, prior to step S101, the method further includes: acquiring storage attribute information of a picture folder to acquire the first storage attribute information of the picture in the picture folder, and acquiring storage attribute information of the picture folder stored in a database to acquire the second storage attribute information of the picture in the picture folder stored in the database.

It should be noted that, as described above, first storage information of a picture is acquired by firstly acquiring a file folder; however, with respect to persons of ordinary skill in the art, the storage information of the picture may be directly acquired with no need to firstly acquiring the file folder.

In this embodiment, the first storage attribute information includes a first storage path and first modification time of the picture, and the second storage attribute information includes a second storage path and second modification time of the picture in a database index.

Specifically, in this embodiment, when the first storage attribute information is acquired in step S101, a picture record on the memory card may be scanned to acquire the first storage attribute information of the picture. Specifically, if the smart terminal is mounted with an Android system, the picture record on the memory card may be scanned by calling a Media Scanner service on the bottom layer of the system.

In this embodiment, stored pictures are only scanned, for example, pictures stored on an SD card, and the other types of files stored are not scanned. In this way, the speed of acquiring the first storage attribute of the picture is high. In other words, the files irrelevant to the synchronization that are filtered are not scanned. The filtering may be implemented by judging the file names. For example, jpg, png and the like formats are pictures, and doc, txt and the like formats are non-pictures.

Specifically, in this embodiment, when during acquiring second storage attribute of the picture stored in a database in step S101, the database may be accessed via a database access interface to acquire the second storage attribute information of the picture stored in the database. Specifically, if the smart terminal is mounted with an Android system, the second storage attribute information of the picture stored in the database may be acquired by accessing the database by using Media Provider as an interface.

In this embodiment, upon step S101 and prior to step S102, the method may further include: generating a first data structure according to the first storage attribute information of the picture; and generating a second data structure according to the second storage attribute information of the picture in the database. With respect to a smart terminal mounted with an Android system, the first data structure may be named as SD Card Folder Time Set (abbreviated as SS), and the second data structure may be named as Media Provider Folder Time Set (abbreviated as MS).

The first data structure and the second data structure at least includes the storage path and the modification time in the storage attribute information of the picture.

In S102, the first storage attribute information is compared with the second storage attribute information to generate a corresponding comparison result.

Specifically, the comparing the first storage attribute information with the second storage attribute information to generate a corresponding comparison result in step S102 includes: comparing the first data structure generated according to the first storage attribute information of the picture with the second data structure generated according to the second storage attribute information of the picture to generate the corresponding comparison result.

In this embodiment, since the first data structure and the second data structure both includes a picture storage path and modification time, the comparison result is determined by comparing the picture storage path and the modification time in the first data structure with the picture storage path and the modification time in the second data structure.

FIG. 2 is a schematic application diagram illustrating comparison according to Embodiment 2 of the present application. As illustrated in the example in FIG. 2, when a photo album is started, a picture management program, such as the photo album scans picture files in an SD card, and finds picture files and a picture file folder (a file folder including pictures), wherein the information herein is recorded as A (first storage attribute information); and then the photo album accesses a database via Media Provider to collect the picture files and the picture file folder, wherein the information is recorded as B (second storage attribute information). Through comparison between the information A and the information B, A and B are subjected to an intersection relationship as illustrated in FIG. 2, and the information included in B but not included in A is E; the information included in A but not included in B is F; and the information included both in A and B and subjected to modification is D.

In S103, a corresponding synchronization policy is generated according to different comparison results, and the second storage attribution information in the database is synchronized according to the determined synchronization policy.

Referring to the example in FIG. 2, the information included in B but not included in A is E, and E is deleted; the information included in A but not included in B is F, and F is added to B; and the information included both in A and B and subjected to modification in A is D, and D is updated to B.

The synchronization policy may be defined according to such operations on the picture as delete, modify and add. For example:

firstly processing pictures which are not present in the SD card but are still recorded in the database, that is, pictures with blank first storage attribute information, and deleting in batches second storage attribute information of the pictures from the database; secondly processing pictures which are modified, for example, the first storage information has valid data but is modified, in the SD card but with the original information thereof being still recorded in the database, and adding the latest modification information to the second storage attribute information; and finally processing pictures added to the SD card, that is, new first storage attribute information, and directly adding the pictures to the database as new second storage attribute information.

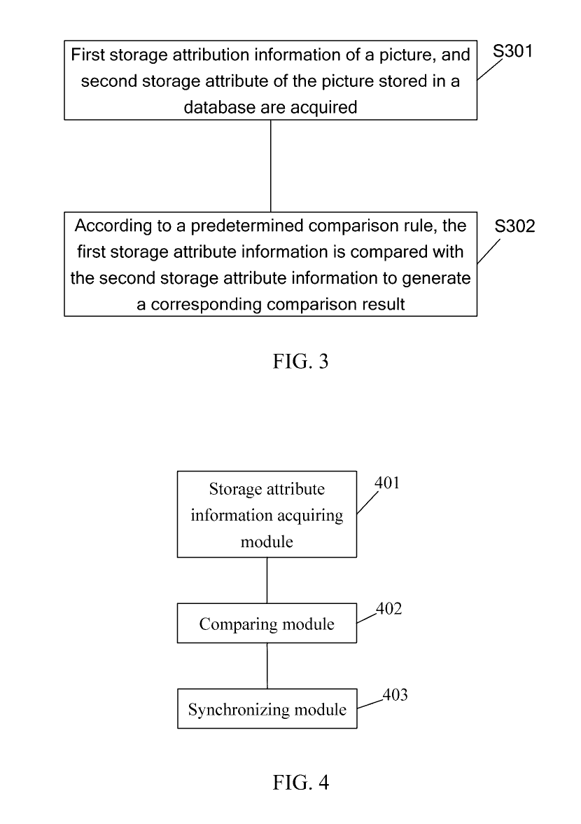

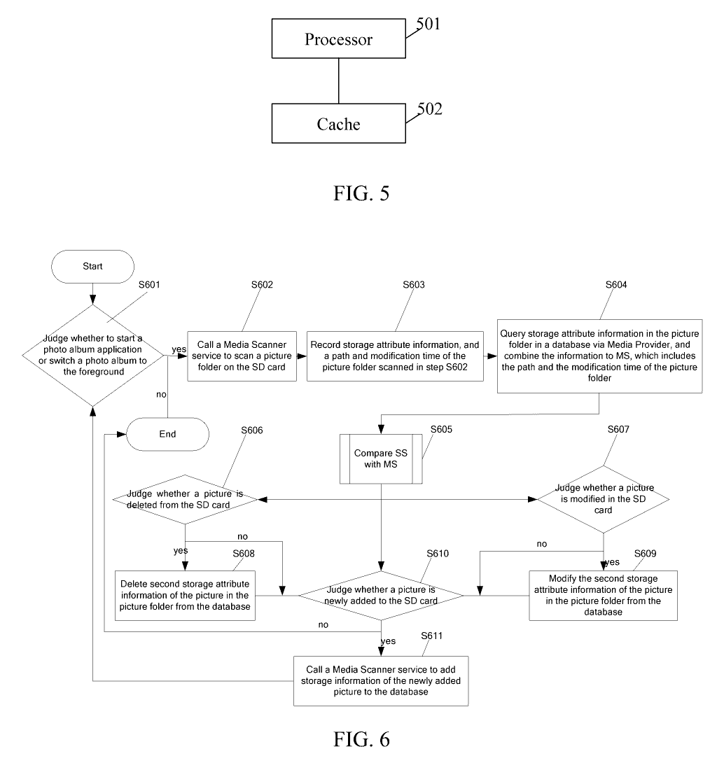

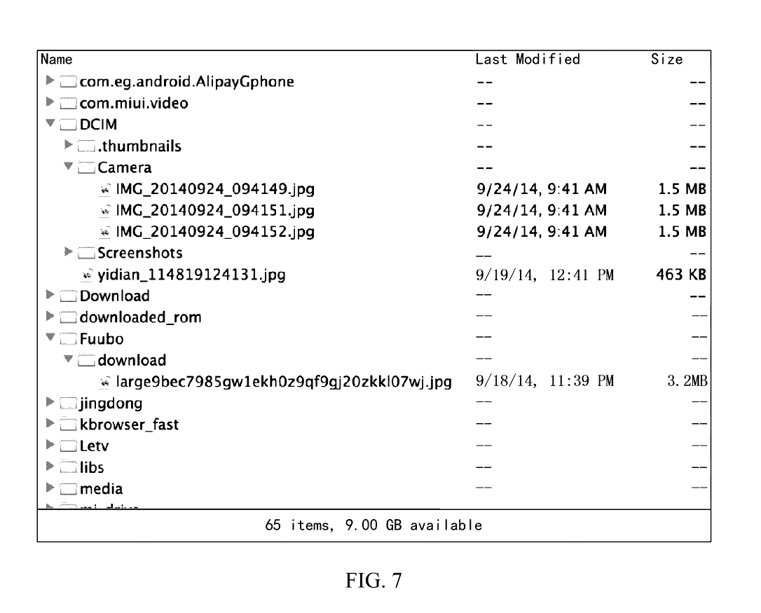

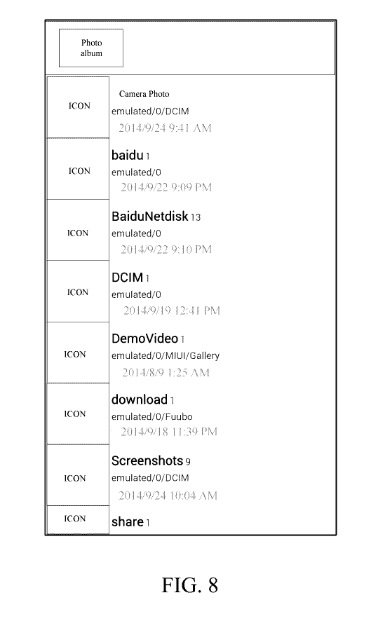

FIG. 3 is a schematic flowchart illustrating a picture system synchronization method according to Embodiment 3 of the present application. As illustrated in FIG. 5, the method may at least include the following steps:

In S301, first storage attribution information of a picture, and second storage attribute of the picture stored in a database are acquired.

In S302, according to a predetermined comparison rule, the first storage attribute information is compared with the second storage attribute information to generate a corresponding comparison result.

In this embodiment, the comparison rule may be:

the following three cases possibly occur to the comparison result:

(1) The first storage path in the first storage attribute information is the same as the second storage path in the second storage attribute information whereas the first modification time in the first storage attribute information is different from the second modification time in the second storage attribute information, and generating the corresponding second storage attribute information needs synchronous update of the comparison result.

(2) The first storage path in the first storage attribute information is different from the second storage path in the second storage attribute information, and generating the corresponding second storage attribute information needs synchronous update of the comparison result.

(3) The first storage path and the first modification time in the first storage attribute information are respectively the same as the second storage path and the second modification time in the second storage attribute information, and generating the corresponding second storage attribute information needs synchronous update of the comparison result.

The comparison rule in this embodiment corresponds to the synchronization rule in the embodiment as illustrated in FIG. 2.

In S303, a corresponding synchronization policy is determined according to different comparison results, and the second storage attribution information in the database is synchronized according to the determined synchronization policy.

In this embodiment, the comparison case (3) does not need to be processed. Therefore, the comparison cases (1) and (2) may be merged. The details may be referenced to FIG. 6 hereinafter, which are thus not described herein any further.

FIG. 4 is a schematic structural diagram illustrating a file system synchronization apparatus according to Embodiment 4 of the present application. As illustrated in FIG. 4, the apparatus may at least include: a storage attribute information acquiring module 401, a comparing module 402 and a synchronizing module 403.

The storage attribute information acquiring module 401 is configured to acquire first storage attribution information of a picture and second storage attribute of the picture stored in a database.

The comparing module 402 is configured to compare the first storage attribute information with the second storage attribute information to generate different comparison results.

The synchronizing module 403 is configured to determine a corresponding synchronization policy according to the different comparison results, and synchronize the second storage attribution information in the database according to the determined synchronization policy.

Optionally, in this embodiment, the storage attribute information acquiring module 401 is further configured to scanning first storage attribute information corresponding to a picture record in a memory card to acquire the first attribute information of the picture.

Optionally, in this embodiment, the storage attribute information acquiring 401 is further configured to access the database via a database access interface to acquire the second storage attribute information of the file stored in the database.

Specifically, the first storage attribute information may include a first storage path and first modification time of the picture, and the second storage attribute information may include a second storage path and second modification time of the picture in a database index.

Optionally, the comparing module 402 is further configured to generate a comparison result according to the following rule:

the first storage path in the first storage attribute information is the same as the second storage path in the second storage attribute information whereas the first modification time in the first storage attribute information is different from the second modification time in the second storage attribute information, and generating the corresponding second storage attribute information needs synchronous update of the comparison result;

the first storage path in the first storage attribute information is different from the second storage path in the second storage attribute information, and generating the corresponding second storage attribute information needs synchronous update of the comparison result; or

the first storage path and the first modification time in the first storage attribute information are respectively the same as the second storage path and the second modification time in the second storage attribute information, and generating the corresponding second storage attribute information needs synchronous update of the comparison result.

Optionally, in this embodiment, the storage attribute information acquiring module 401 is further configured to generate a first data structure according to the first storage attribute information of the picture, and generate a second data structure according to the second storage attribute information of the picture in the database.

Specifically, the comparing module 402 is specifically further configured to compare the first data structure generated according to the first storage attribute information of the picture with the second data structure generated according to the second storage attribute information of the picture to generate the corresponding comparison result.

Optionally, in this embodiment, the storage attribute information acquiring module 401 is further configured to acquire storage attribute information of a picture folder to acquire first storage attribute information of a picture in the picture folder, and acquire storage attribute information of the picture folder in the database to acquire second storage attribute information of the picture in the picture folder stored in the database.

FIG. 5 is a schematic structural diagram illustrating a smart terminal according to Embodiment 5 of the present application. As illustrated in FIG. 5, the smart terminal may at least include a processor 501 and a cache 502.

The processor 501 is configured to acquire first storage attribution information of a picture, and second storage attribute of the picture stored.

The processor 501 is configured to compare the first storage attribute information with the second storage attribute information to generate different comparison results.

The processor 501 is configured to determine a corresponding synchronization policy according to the different comparison results, and synchronize the second storage attribution information in the database according to the determined synchronization policy.

The cache 502 is configured to buffer a processing result of the processor 501.

Optionally, in this embodiment, the processor 501 is further configured to scan first storage attribute information corresponding to a picture record in a memory card to acquire the first attribute information of the picture.

Optionally, in this embodiment, the processor 501 is further configured to access the database via a database access interface to acquire the second storage attribute information of the file stored in the database.

Specifically, the first storage attribute information may include a first storage path and first modification time of the picture, and the second storage attribute information may include a second storage path and second modification time of the picture in a database index.

Optionally, the processor 501 is further configured to generate a comparison result according to the following rule:

the first storage path in the first storage attribute information is the same as the second storage path in the second storage attribute information whereas the first modification time in the first storage attribute information is different from the second modification time in the second storage attribute information, and generating the corresponding second storage attribute information needs synchronous update of the comparison result;

the first storage path in the first storage attribute information is different from the second storage path in the second storage attribute information, and generating the corresponding second storage attribute information needs synchronous update of the comparison result; or

the first storage path and the first modification time in the first storage attribute information are respectively the same as the second storage path and the second modification time in the second storage attribute information, and generating the corresponding second storage attribute information needs synchronous update of the comparison result.

Optionally, in this embodiment, the processor 501 is further configured to generate a first data structure according to the first storage attribute information of the picture, and generate a second data structure according to the second storage attribute information of the picture in the database.

Specifically, the processor 501 is further configured to compare the first data structure generated according to the first storage attribute information of the picture with the second data structure generated according to the second storage attribute information of the picture to generate the corresponding comparison result.

Optionally, in this embodiment, the processor 501 is further configured to acquire storage attribute information of a picture folder to acquire the first storage attribute information of the picture in the picture folder, and acquire storage attribute information of the picture folder stored in a database to acquire the second storage attribute information of the picture in the picture folder stored in the database.

FIG. 6 is a schematic flowchart illustrating a method for file system synchronization according to Embodiment 6 of the present application. As illustrated in FIG. 6, in this embodiment, description is given using processing pictures on an SD card by using a photo album in an Android smart phone. In the embodiment hereinafter, storage attribute information of a picture folder is used as a basis of a picture storage attribute. This method at least includes the following steps:

S601: judging whether to start a photo album application or switch a photo album to the foreground, if it is judged to start a photo album application or switch a photo album to the foreground, performing step S602, and otherwise, ending the process;

S602: calling a Media Scanner service to scan a picture folder on the SD card;

S603: recording storage attribute information, and a path and modification time of the picture folder scanned in step S602, and combining the information to SS;

S604: querying storage attribute information in the picture folder in a database via Media Provider, and combining the information to MS, which includes the path and the modification time of the picture folder;

S605: comparing SS with MS, and respectively performing steps S606 and S608;

S606: judging whether a picture is deleted from the SD card, if a picture is deleted form the SD card, performing step S608, and otherwise, performing step S610;

S607: judging whether a picture is modified in the SD card, if a picture is modified in the SD card, performing step S609, and otherwise, performing step S610;

S608: deleting second storage attribute information of the picture in the picture folder from the database;

S609: modifying the second storage attribute information of the picture in the picture folder from the database;

S610: judging whether a picture is newly added to the SD card, and if a picture is newly added to the SD card, performing step S611; and

S611: calling a Media Scanner service to add storage information of the newly added picture to the database.

File folders in SS and MS are compared to collect file folders in SS and MS which have the same file folder path and the same file folder modification time, and exclude the folders from processing; collect folders A in SS and MS which have the same file folder path but different file folder modification time, wherein the folders A may be subjected to addition, or modification or deletion; and collect file folders B in SS and MS which have different file folder paths, and combining A and B into a file folder set C to be processed.

With respect to each file folder in C, all the picture paths and modification time information Media Provider Folder Images, abbreviated as MFI which are recorded under the file folder in the database via Media Provider; and practically existent picture paths and modification time information SC Card Folder Images, abbreviated as SFI, in a storage device are searched via the SD card; similar to the comparison operation in the file folder, pictures in MFI and SFI are compared to detect whether they are the same or different, to find the pictures (present in MFI but not in SFI) which are already deleted from the SD card, and information of the MFI pictures is deleted from the database; the pictures (present in both MFI and SFI, wherein the SFI pictures are detected to have been modified according to the modification time of the pictures) which are already modified in the SD card are found, and information of the corresponding MFI pictures is modified in the database; new pictures (present in SFI but not in MFI) added to the SD card are found, and information of the newly added pictures is added to the database by using the Media Scanner service provided by the Android system.

Since adding pictures is a very resource consuming operation, but deleting pictures and modifying pictures relatively consume less time, to reduce the load of the system, the operations for deletion and modification are firstly performed, and with respect to newly added pictures, information of each ten pictures are added in batches by triggering the system Media Scanner.

Another embodiment of the present application further provides a non-transitory computer-readable storage medium storing executable instructions that, when executed by an electronic device, cause the electronic device to: acquiring first storage attribution information of a file, and second storage attribute information of the file from a database where the file stored; comparing the first storage attribute information with the second storage attribute information to generate a corresponding comparison result; and determining a corresponding synchronization policy according to different comparison results, and synchronizing the second storage attribution information in the database according to the determined synchronization policy.

The above described apparatus embodiments are merely for illustration purpose only. The modules which are described as separate components may be physically separated or may be not physically separated, and the components which are illustrated as modules may be or may not be physical modules, that is, the components may be located in the same position or may be distributed into a plurality of network modules. A part or all of the modules may be selected according to the actual needs to achieve the objectives of the technical solutions of the embodiments. Persons of ordinary skill in the art may understand and implement the present application without paying any creative effort.

According to the above embodiments of the present invention, a person skilled in the art may clearly understand that the embodiments of the present invention may be implemented by means of hardware or by means of software plus a necessary general hardware platform. Based on such understanding, portions of the technical solutions of the present application that essentially contribute to the related art may be embodied in the form of a software product, the computer software product may be stored in a computer readable storage medium. The computer readable storage medium includes any mechanism for storing or transferring information in a computer readable form, such as a ROM/RAM, a magnetic disk, a CD-ROM and the like, including several instructions for causing a computer device (a personal computer, a server, or a network device) to perform the methods in various embodiments of the present application, or in certain portions of the embodiments of the present application.

It should be finally noted that the above-described embodiments are merely for illustration of the present application, but are not intended to limit the present application. Although the present application is described in detail with reference to these embodiments, a person skilled in the art may also make various modifications to the technical solutions disclosed in the embodiments, or make equivalent replacements to a part of the technical features contained therein. Such modifications or replacement, made without departing from the principles of the present invention, shall fall within the scope of the present application.

What is claimed is:

1. A method for file system synchronization at an electronic device, comprising:
acquiring first storage attribution information of a file, and second storage attribute information of the file from a database where the file stored;
comparing the first storage attribute information with the second storage attribute information to generate a corresponding comparison result; and
determining a corresponding synchronization policy according to different comparison results, and synchronizing the second storage attribution information in the database according to the determined synchronization policy.

2. The method according to claim 1, wherein the acquiring first storage attribution information of a file comprises: scanning first storage attribute information corresponding to a file record in a memory card to acquire the first attribute information of the file.

3. The method according to claim 1, wherein the acquiring second storage attribute information of the file from a database where the file stored comprises: accessing the database via a database access interface to acquire the second storage attribute information of the file stored in the database.

4. The method according to claim 1, wherein the first storage attribute information comprises a first storage path and first modification time of the file, and the second storage attribute information comprises a second storage path and second modification time in a database index.

5. The method according to claim 4, wherein the comparing the first storage attribute information with the second storage attribute information to generate a corresponding comparison result comprises:
the first storage path in the first storage attribute information is the same as the second storage path in the second storage attribute information whereas the first modification time in the first storage attribute information is different from the second modification time in the second storage attribute information, and generating the corresponding second storage attribute information needs synchronous update of the comparison result;
the first storage path in the first storage attribute information is different from the second storage path in the second storage attribute information, and generating the corresponding second storage attribute information needs synchronous update of the comparison result; or
the first storage path and the first modification time in the first storage attribute information are respectively the same as the second storage path and the second modification time in the second storage attribute information, and generating the corresponding second storage attribute information needs synchronous update of the comparison result.

6. The method according to claim 1, further comprising: generating a first data structure according to the first storage attribute information of the file; and generating a second data structure according to the second storage attribute information of the file in the database.

7. The method according to claim 6, wherein the comparing the first storage attribute information with the second storage attribute information to generate a corresponding comparison result comprises: comparing the first data structure generated according to the first storage attribute information of the file with the second data structure generated according to the second storage attribute information of the file to generate the corresponding comparison result.

8. The method according to claim 1, further comprising: acquiring storage attribute information of a file folder to acquire the first storage attribute information of the file in the file folder; and acquiring storage attribute information of the file folder stored in a database to acquire the second storage attribute information of the file in the file folder stored in the database.

9. The method according to any one of claims 1, wherein the file comprises multimedia.

10. An electronic device, comprising:
at least one processor; and
a memory communicably connected with the at least one processor for storing instructions executable by the at least one processor, wherein execution of the instructions by the at least one processor causes the at least one processor to:
acquire first storage attribution information of a file and second storage attribute information of the file from a database where the file stored;
compare the first storage attribute information with the second storage attribute information to generate different comparison results; and
determine a corresponding synchronization policy according to the different comparison results, and synchronize the second storage attribution information in the database according to the determined synchronization policy.

11. A non-transitory computer-readable storage medium storing executable instructions that, when executed by an electronic device, cause the electronic device to:
acquire first storage attribution information of a file, and second storage attribute information of the file from a database where the file stored;
compare the first storage attribute information with the second storage attribute information to generate a corresponding comparison result; and
determine a corresponding synchronization policy according to different comparison results, and synchronize the second storage attribution information in the database according to the determined synchronization policy.
